(19) United States
(12) Patent Application Publication
(10) Pub. No.: US 2026/0233981 A1
(43) Pub. Date: Aug. 13, 2026

(54) Lifting Column for Lifting a Vehicle Having a Ground Support, a Lifting System with Such Lifting Column and an Associated Method for Lifting a Vehicle

(71) Applicant: Stertil B.V., Kootstertille (NL)

(72) Inventors: Arjen Eisma, Kootstertille (NL); Hilbrand Jan Kamminga, Kootstertille (NL); Albert Thaeke Russchen, Kootstertille (NL)

(21) Appl. No.: 19/152,974

(22) PCT Filed: Feb. 2, 2024
(86) PCT No.: PCT/NL2024/050050

§ 371 Date: Aug. 1, 2025

(30) Foreign Application Priority Data
Feb. 3, 2023 (NL) 2034084
Jun. 1, 2023 (NL) 2034967

(51) Int. Cl. B66F 7/28; B66F 3/46

(52) U.S. Cl. CPC B66F 7/28; B66F 3/46

(57) ABSTRACT

Provided herein is a lifting column for lifting a vehicle having a ground support, a lifting system with such lifting column and an associated method for lifting a vehicle. The lifting column includes a frame comprising a ground support, and the frame being provided with a moveable carrier having an engagement element that is configured for engaging the vehicle at a jack point when carrying the vehicle; and a lifting mechanism with a drive which acts on the carrier and is configured for raising and/or lowering the carrier relative to the frame. The ground support includes two leg supports that extend under the vehicle when lifting the vehicle, and wherein the two leg supports are configured for providing stability in a first direction; and side supports configured for providing stability in a second direction that is substantially perpendicular to the first direction.

### CROSS-REFERENCE TO RELATED APPLICATIONS

This application is the United States national phase of International Patent Application No. PCT/NL2024/050050 Feb. 2, 2024, and claims priority to The Netherlands Patent Application Nos. 2034084 filed Feb. 3, 2024 and 2034967 filed Jun. 1, 2023, the disclosures of which are hereby incorporated by reference in their entireties.

### BACKGROUND OF THE INVENTION

### Field of the Invention

The invention relates to a lifting column, more specifically a mobile lifting column for lifting vehicles. In practice, lifting columns are used for lifting passenger cars, trucks, busses, or other vehicles. Such lifting column is often incorporated in a lifting system comprising one or more of these lifting columns. The lifting column can be wired or wireless.

### Description of Related Art

Conventional lifting columns comprise a frame with a carrier that is connected to a drive for moving the carrier upwards and downwards along a mast of the frame. For example, a lifting column is disclosed in U.S. 2006/0182563.

A problem with such conventional lifting columns is that they engage the wheels of the vehicle to enable lifting the vehicle. Especially when lifting electric vehicles, such as busses and cars, this is inconvenient. Such electric vehicles often require inspection and maintenance of the wheel and its direct vicinity. When using conventional lifting columns, it is often required to use one or more so-called axle supports for supporting the load (vehicle). After positioning such axle support(s), a lifting column can be removed from the vehicle, and access to the wheel for inspection and maintenance is allowed. This use of axle supports requires additional material and additional steps when working on such electric vehicles. Furthermore, this may introduce any additional safety hazards.

### SUMMARY OF THE INVENTION

The present invention has for its object to obviate or at least reduce one or more of the aforementioned problems.

For this purpose, the present invention provides a lifting column for lifting a vehicle, wherein the lifting column comprises:
a frame comprising a ground support, and the frame being provided with a moveable carrier having an engagement element that is configured for engaging the vehicle at a jack point when carrying the vehicle; and
a lifting mechanism with a drive which acts on the carrier and is configured for raising and/or lowering the carrier relative to the frame,

wherein the ground support comprises:
two leg supports that extend under the vehicle when lifting the vehicle, and wherein the two leg supports are configured for providing stability in a first direction; and
side supports configured for providing stability in a second direction that is substantially perpendicular to the first direction.

In the context of the present invention the carrier relates to the moving parts of the lifting column that carry the vehicle when lifting such vehicle. This carrier is driven by a drive, such as a hydraulic drive, pneumatic drive and/or electric drive. The present invention further relates to lifting columns, preferably mobile lifting columns, and more preferably to wireless mobile lifting columns.

The carrier of the lifting column is capable of carrying the vehicle that needs to be lifted. The carrier moves upwards and downwards relative to the frame and more specifically moves along the mast of the lifting column. The carrier comprises a carrying part that is configured for carrying the vehicle, or at least a part thereof. The carrier further comprises a guiding part that enables a guiding movement of the carrier relative to the frame and more specifically the mast of the lifting column.

In one of the presently preferred embodiments of the invention the drive is embodied as an integrated hydraulic cylinder as disclosed in U.S. 2016/0052757. Preferably, the carrying part is provided as one piece. It will be understood that other configurations for the carrier can also be envisaged according to the invention including a two-piece carrying part, for example.

According to the invention the movable carrier is provided with an engagement element that is configured for engaging the vehicle at one of the vehicle's jack points when carrying the vehicle. This enables lifting a vehicle at such jack point without engaging a vehicle wheel. This enables access to the wheel for inspection, maintenance, repair et cetera. This is especially effective when lifting electric vehicles.

A further advantage when engaging a vehicle jack point with the engagement element is the flexibility when lifting vehicles that have an independent suspension that causes a wheel to tilt inwardly (or outwardly). Engaging a jack point obviates the difficulties when engaging a vehicle wheel with a mobile lifting column and requiring one or more axle supports. This improves the flexibility of the lifting column according to the present invention for lifting different vehicle types.

According to the present invention the ground support comprises two (or more) leg supports that extend under the vehicle when the lifting column is positioned for lifting the vehicle, and wherein these at least two leg supports are configured for providing stability in a first direction. Typically, in most cases when lifting a vehicle with a lifting column, the legs will extend in a width direction of the vehicle. The ground support further comprises side supports that are configured for providing stability in a second direction that is substantially perpendicular to the first direction. Typically, this second direction is in the width direction of the lifting column that in use corresponds to the length direction of the vehicle that is being lifted.

The ground support provides stability to the lifting column when lifting a vehicle and when moving such a lifting column through a workshop. The leg supports provide stability in a first direction such that a tilting movement in such first direction is prevented. The side supports provide stability in a second direction and prevent tilting of the lifting column in this second direction. Together the leg supports and side supports provide a stable ground support that assures a stable operation for the lifting column when lifting a vehicle, thereby preventing any undesired tilting movement of the lifting column.

The lifting column according to the present invention enables an effective lifting operation with a reduced number of steps by obviating the need for axle supports, and provides a safer working environment. Vehicles are usually lifted with a number of lifting columns. Each of these lifting columns is designed to carry their respective load. Preferably, each mast of an individual lifting column is designed to carry this respective part of the vehicle load. The ground support with the leg supports and the side supports provide an improved stability against undesired tilting of the lifting column in all directions. This improves the overall safety when lifting a vehicle.

Furthermore, the improved stability with the ground support of the lifting column according to the present invention renders the lifting of electric vehicles easier. This is achieved by providing access to the wheel and its direct vicinity without having to remove the lifting column and position axle supports.

In a preferred embodiment of the invention the side supports of the lifting column extend beyond the leg supports in a width direction of the lifting column.

Providing side supports that extend beyond the leg supports as seen in a width direction of the lifting column, which in most cases in use for lifting a vehicle corresponds to the length direction of the vehicle, the (effective) surface of the ground support is increased. Therefore, having the side supports extending beyond the leg supports in the width direction of the lifting column further improves the overall stability of the lifting column, especially when lifting a vehicle.

In a preferred embodiment of the present invention the leg supports extend substantially parallel to the carrier with the engagement element and the leg supports extend beyond the carrier.

The leg supports typically extend in the direction parallel to the carrier and perpendicular to the width direction of the lifting column. In use, the leg supports typically extend in a width direction of the vehicle that is being lifted. By providing leg supports that extend beyond the carrier in this direction the surface of the ground support is further increased, and the overall stability of the lifting columns is further improved.

In an embodiment of the present invention wherein the leg supports extend beyond the carrier, the leg supports are optionally connected to each other at their free ends. This connection can be achieved by providing a plate, beam, rod or other suitable connection. This connection between the leg supports provides additional robustness and stability to the frame of the lifting column thereby also improving the overall stability thereof.

In one of the presently preferred embodiments of the invention the leg supports are positioned such that the legs supports are on one side of the wheel when lifting the vehicle.

By providing the leg supports one side of the wheel access to such wheel is made easier, thereby improving possibilities for inspection, maintenance and repair.

In a further preferred embodiment of the invention the carrier is at least partly removable from the frame to enable changing the engagement element.

Providing a removable carrier part, with the removable part corresponding to or including the engagement element, enables adjusting the size and shape of such engagement element to the vehicle that requires lifting.

In a further preferred embodiment of the invention the engagement element can be extended and retracted relative to the frame.

By providing an extension/retraction mechanism the engagement element can be extended and retracted in a substantially horizontal plane, thereby being positioned relative to the frame and the vehicle. This improves the flexibility of positioning the lifting column with such engagement element.

In a further preferred embodiment the engagement element can be raised and/or lowered relative to the carrier.

This raising or lowering mechanism of the engagement element enables positioning the engagement element in a height direction relative to the carrier to improve the overall flexibility for lifting different vehicle types. In a further preferred embodiment the engagement element comprises an adapter. Such adapter may further improve the flexibility when lifting different vehicle types.

In an alternative preferred embodiment of the invention the leg supports on both sides of the wheel are positioned asymmetrically relative to the carrier.

Positioning the leg supports asymmetrically provides additional space for the wheel, while the engagement element engages the desired jack point and the wheel is positioned between leg supports when lifting the vehicle. This increases the effective surface of the ground support thereby further reducing the risk of undesired tilting of the lifting column. Optionally, in case the stability with the asymmetrically positioned leg supports is sufficient for lifting any desired vehicle, the side supports can even be omitted from the ground support, thereby resulting in an alternative lifting column.

In a further preferred embodiment of the invention the carrier comprises a rotation axis to enable rotation of the carrier relative to the frame.

By providing a rotation axis the carrier may rotate in a substantially horizontal plane thereby improving the flexibility for positioning of the engagement element relative to a jack point of the vehicle to be lifted. In such embodiment the rotation axis preferably extends in a substantially vertical direction and thereby substantially parallel to the elongated frame.

In a further preferred embodiment of the invention the column comprises a load sensor configured for determining the load that is carried by carrier.

By providing a load sensor the actual load that is carried by carrier, and its engagement element, can be measured and any overload can be detected such that an operator can be provided with a warning signal, for example.

In a further preferred embodiment of the invention the lifting column further comprises a side-shift mechanism for the leg supports.

Providing a side-shift mechanism for the leg supports enable changing the mutual distance of the leg supports in a width direction of the lifting column. This improves the flexibility for lifting different vehicle types.

In a further preferred embodiment of the invention the lifting column further comprises a steering mechanism with two or more steering wheels.

Providing the lifting column with a steering mechanism having two or more steering wheels provides improved stability to the lifting column, also when moving the lifting column. The steering wheels are preferably provided at a distance from each other, more preferably the steering wheels are provided on different sides of the frame/mast of the lifting column. Turning radius can be less than 2 meters.

In one of the presently preferred embodiments of the invention the steering wheels are placed at a mutual distance that is larger than a width of a mast of the frame that enables upwards and downwards movement of the carrier. This larger distance provides a wider wheelbase on the displacement/pallet truck mechanism and improves stability during displacement/relocation of the column.

More preferably, the steering mechanism is operatively connected to a pallet truck mechanism to provide optimal flexibility when moving the lifting column.

In a further presently preferred embodiment of the invention the lifting column comprises an adjustment mechanism that enables sideways adjustment of leg supports.

Such sideways adjustment provides further flexibility to the lifting column, specifically when dealing with different vehicle types. Preferably, the adjustment mechanism is configured for connecting a leg support to a side support with a connecting mechanism, such as a gear assembly. Such gear assembly comprises a number of gears that enable the leg support(s) to remain substantially parallel to each other and substantially perpendicular to the rear of the lifting column. This maintains a safe operation of the lifting column, while improving the aforementioned flexibility. More preferably, some of the gears are integrated in the construction of the leg support(s) and/or side support(s). This renders the adjustment mechanism safe and/or cost effective.

In a further presently preferred embodiment of the invention the lifting column comprises a spring loaded adapter configured for engaging a vehicle, and a mirror configured for checking engagement with the vehicle.

Providing a spring loaded adapter provides improved safety when engaging a vehicle, such as an electric bus. Providing a mirror that is configured for checking the engagement between the adapter and the vehicle improves the overall safety when lifting a vehicle. Preferably, the adapter further comprises an axial play configured for allowing some movement of the column during positioning thereof. Such positioning may involve the lowering of the pallet truck mechanism of the mobile lifting column. This further improves flexibility and safety when lifting a vehicle.

The invention further relates to a lifting system for lifting a vehicle, the lifting system comprises at least one lifting column as described herein.

The lifting system provides the same or similar effects and/or advantages as described for the lifting column, more specifically the mobile lifting column.

A number of lifting columns can be grouped together as a lifting system. In an embodiment of such lifting system according to the invention at least two lifting columns are being used for lifting the vehicle. In practice, mostly four or even more lifting columns will be grouped together in a lifting system. This grouping can be permanent or flexible. During the lifting operation movement of the individual carriers is controlled by the controller involving synchronization of these movements. In case one of the carriers has moved too fast in the ascent mode and is too high as compared to other carriers of the other lifting columns, in one of the embodiments of the invention the power supply to this carrier is either directly or indirectly lowered such that the other carriers can catch up. Alternatively, the power supply to the other carriers is either directly or indirectly increased such that the other carriers can catch up. In the descent mode power supply is increased for a carrier that has moved too slowly to enable this carrier to catch up with the other carriers. Alternatively, the power supply to the other carriers is either directly or indirectly lowered so that the carrier can catch up.

The invention further also relates to a method for lifting a vehicle, wherein the method comprises the steps of:
providing a lifting system with at least one lifting column as described herein,
positioning the lifting column relative to the vehicle; and
engaging the vehicle at a jack point and lifting the vehicle.

Such method provides the same effects and/or advantages as described for the lifting column(s) and/or the lifting system.

In one of the preferred embodiments of the invention the method further comprises the step of selecting and mounting an engagement element. This improves the overall flexibility when working with the lifting column and lifting system.

It is noted that features mentioned in relation to the column and/or system can also be applied to the method, and vice versa.

### BRIEF DESCRIPTION OF THE DRAWINGS

The terms Fig., Figs., Figure, and Figures are used interchangeably in the specification to refer to the corresponding figures in the drawings.

Further advantages, features and details of the invention will be elucidated on the basis of preferred embodiments thereof, wherein reference is made to the accompanying drawings in which:

FIG. 1A-C shows the lifting column according to an embodiment of the invention,

FIG. 1D shows the lifting column of FIG. 1A-C with additional features;

FIG. 2A-B shows another lifting column according to the invention;

FIG. 2C shows the lifting column of FIG. 2A-B with additional side supports;

FIG. 3A shows a further lifting column according to the invention;

FIG. 3B shows the lifting column of FIG. 3A with additional side supports;

FIG. 4 shows a lifting system according to an embodiment of the invention with the lifting columns of FIG. 1A-C;

FIG. 5 shows another embodiment of a lifting system according to the invention with lifting columns of FIG. 2A, C in combination with some other lifting columns;

FIG. 6A-F shows another lifting column according to the invention; and

FIG. 7A-G shows another embodiment of a lifting system according to the invention.

### DESCRIPTION OF THE INVENTION

The following description is merely exemplary in nature and is in no way intended to limit the invention, its application or uses. While the disclosure is described as having exemplary attributes and applications, the present disclosure can be further modified. This application is therefore intended to cover any variations, uses, and adaptations of the disclosure using its general principles. Further, this application is intended to cover such departures from the present disclosure as commonly known or customary practice of those skilled in the art to which this disclosure pertains and which fall within the limits of the appended claims. Accordingly, the following description of certain embodiments and examples should be considered merely exemplary and not in any way limiting.

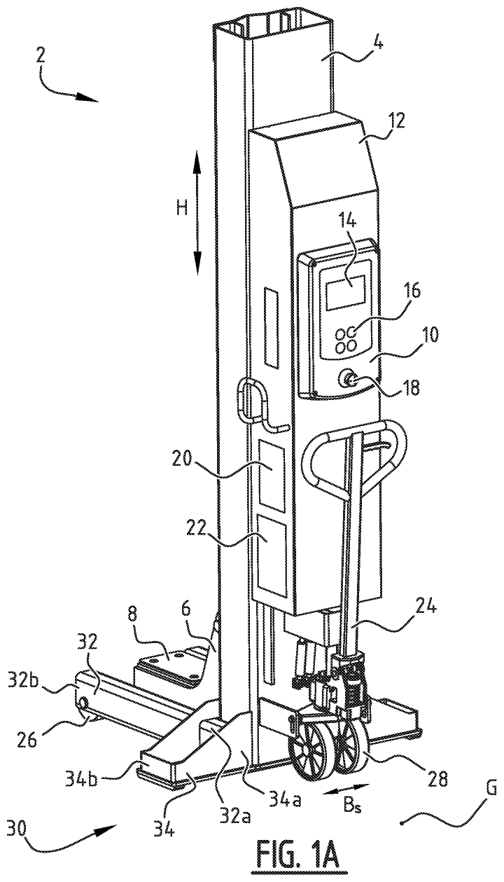

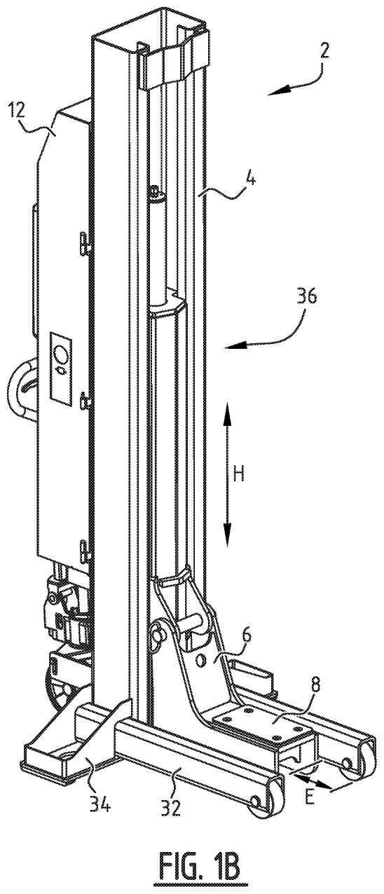

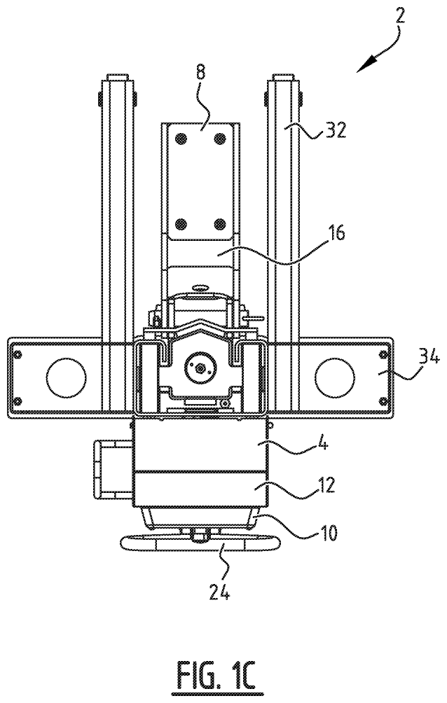

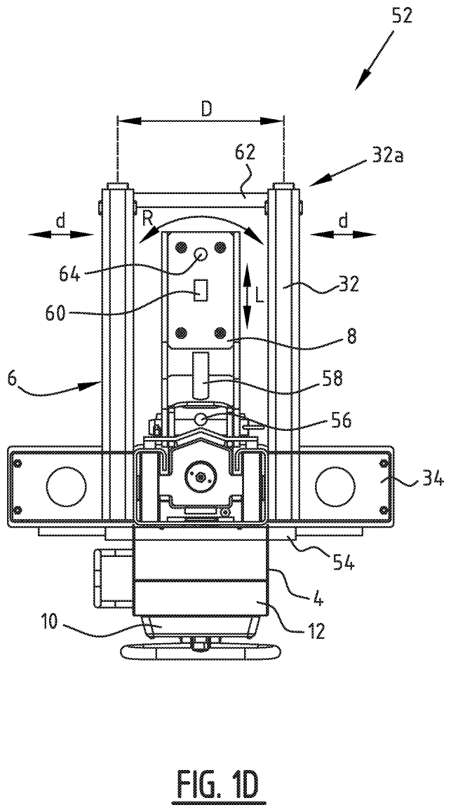

Mobile lifting column 2 (FIG. 1A-C) comprises mast 4 and carrier 6. Carrier 6 comprises engagement element 8 and is movable in direction H along mast 4. Lifting column 2 further comprises control cabinet/terminal 10 that is provided on or in housing 12 and is provided with display 14, inputs or buttons 16, and emergency button 18. Control cabinet 10 comprises the control processor, a memory and other control components. In the illustrated embodiment drive system 20 is provided in housing 12 together with battery 22. Drive system 20 may comprise one or more of an electric, hydraulic, pneumatic drive system. Height adjustment of carrier 6 is in the illustrated embodiment preferably done with the use of mast cylinder 36.

Lifting column 2 can be displaced using pallet truck mechanism 24, front running wheels 26 and steering wheel(s) 28. In the illustrated embodiment steering wheels 28 are placed at mutual distance Bs. Mobile lifting column 2 rests on ground surface G with ground support 30 that comprises leg supports 32 and side supports 34. Leg supports 32 each have first end 32a that is attached to or on the frame with mast 4 of column 2, and second outer end or free end 32b. Side support 34 is at its first end 34a attached to or on the frame with mast 4 of column 2 and has second or free end 34b. Support legs 32 extend beyond carrier 6 over distance E (FIG. 1B).

Alternative mobile lifting column 52 (FIG. 1D) comprises mast 4, carrier 6, engagement element 8, housing 12, control cabinet 10 and the other elements as shown for lifting column 2 in one of FIGS. 1A-C. In addition, mobile lifting column 52 comprises side-shift mechanism 54 that enables leg support 32 to adjust mutual distance D between two leg supports 32.

In addition, carrier 16 comprises rotation axis or rotation shaft 56 that allows movable carrier part with engagement element 8 to rotate in direction R. In addition, or as an alternative, carrier 6 is provided with extension cylinder 58 that enables extending or retracting engagement element 8 in a substantially horizontal direction L. Also optionally, engagement element 8 is connected to height cylinder 60 that enables height adjustment of engagement element 8 relative to carrier 6 in direction H. Furthermore, free ends 32a of leg supports 32 are optionally connected with rod or plate 62. Optionally, carrier 6 is provided with load sensor 64 to measure the load. It will be understood that incorporation of one or more of these additional features of lifting column 52 (FIG. 1D) in lifting column 2 (FIG. 1A-C) resulting in a further alternative embodiment can be envisaged by the skilled person.

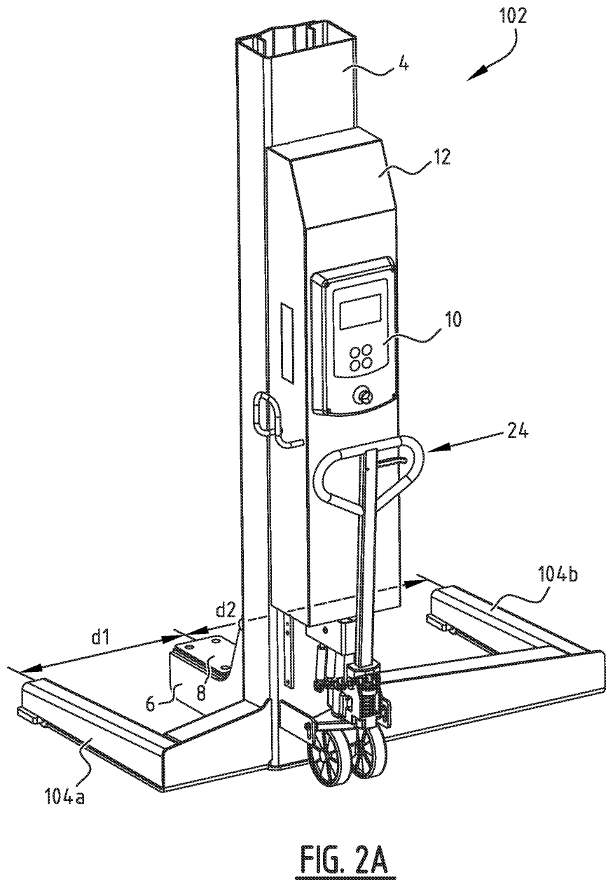

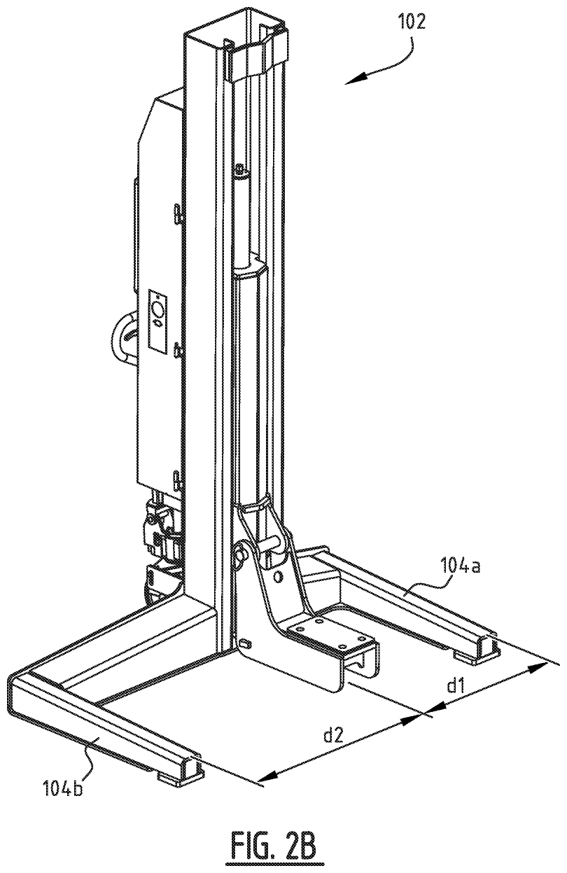

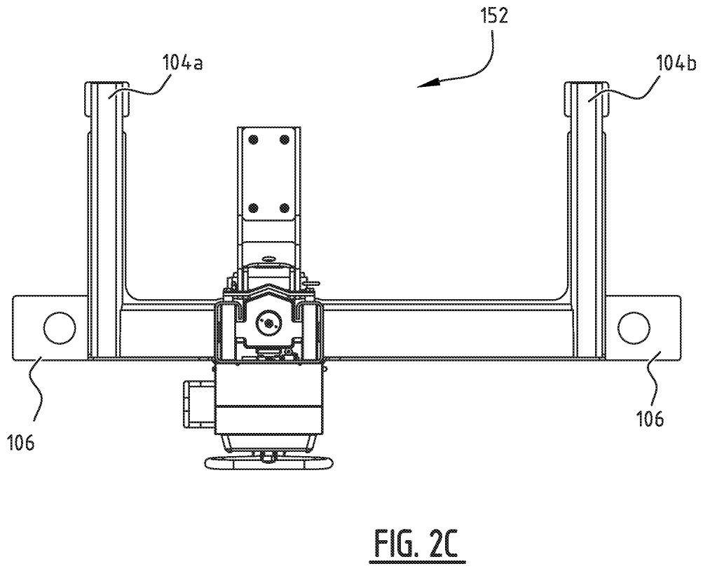

Alternative lifting column 102 (FIGS. 2A-B) comprises mast 4, housing 12, control cabinet 10, displacement or pallet truck mechanism 24 and other suitable components illustrated in association with the lifting column 2 (FIGS. 1A-C) and/or lifting column 52 (FIG. 1D). Lifting column 102 comprises leg supports 104a, 104b. In this embodiment leg supports 104a,b are positioned asymmetrically relative to carrier 6 with engagement element 8, such that leg supports 104a,b have different distances d₁, d₂ relative to carrier 6.

Alternative lifting column 152 having asymmetrically positioned leg supports 104a,b (FIG. 2C) is provided with side supports 106, similar to side supports 34 as illustrated in FIG. 1C, for example. It is noted that other features that are illustrated for lifting column 2, 52, 102 can also be used in combination with lifting column 152, including but not limited to one or more of side-shift mechanism 54, rotation axis 56, extension cylinder 58, height adjustment cylinder 60, connection 62, load sensor 64.

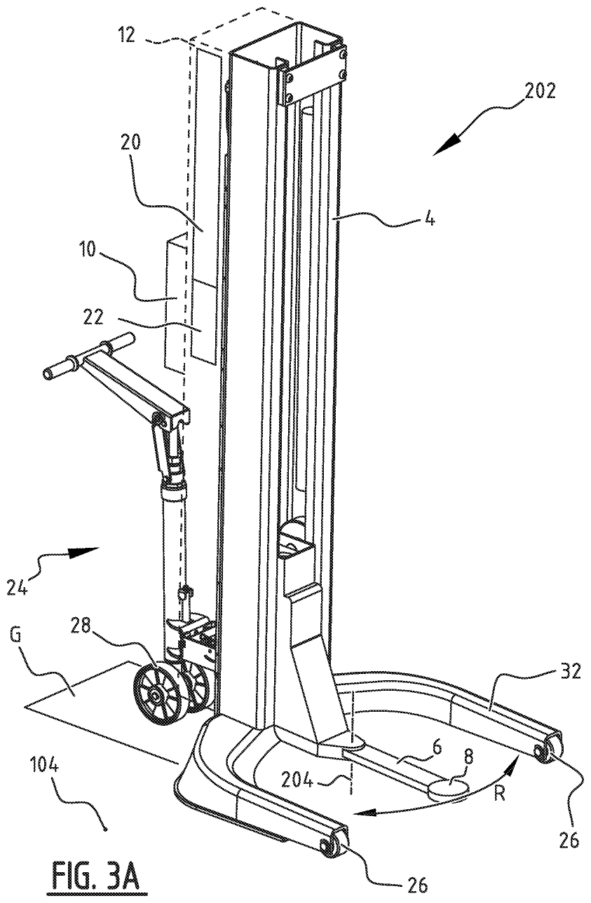

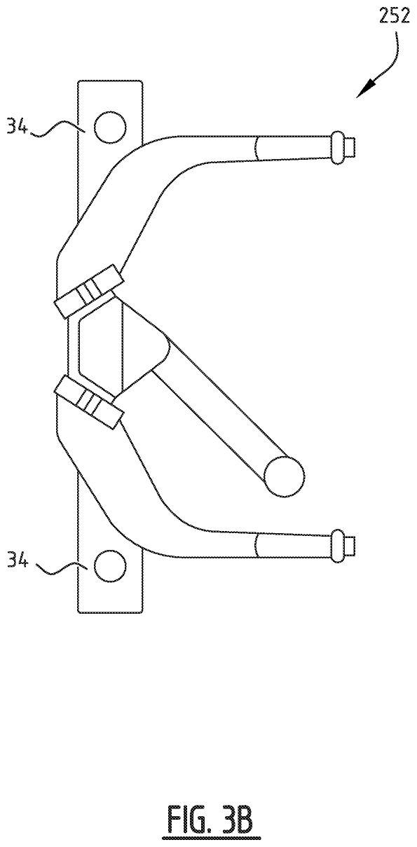

Lifting column 202 (FIG. 3A), comprises mast 4, housing 12, control 10, drive system 20, battery 22, displacement or pallet truck mechanism 24 to displace lifting column 202 over ground surface G using steering wheel 28 and front running wheels 26, and other relevant components of one or more of the other illustrated embodiments of lifting columns 2, 52, 102, 152. Leg supports 32 are provided, with carrier 6 having engagement element 8 being movable between leg supports 26 in a substantially horizontal plane over rotation axis 204 in direction R.

Mobile lifting column 252 (FIG. 3B) resembles lifting column 202 having additional side supports 34, similar to side supports 34 as illustrated in FIG. 1C, for example.

It will be understood that features of different mobile lifting columns 2, 52, 102, 152, 202, 252 can be combined with each other to generate new alternative embodiments. This may involve applying one or more of these features to a different lifting column, for example including one or more of a side-shift mechanism 54, rotation axis 56, extension cylinder 58, height adjustment cylinder 60, connecting rods 62 and/or load sensor 64 in one of the other embodiments.

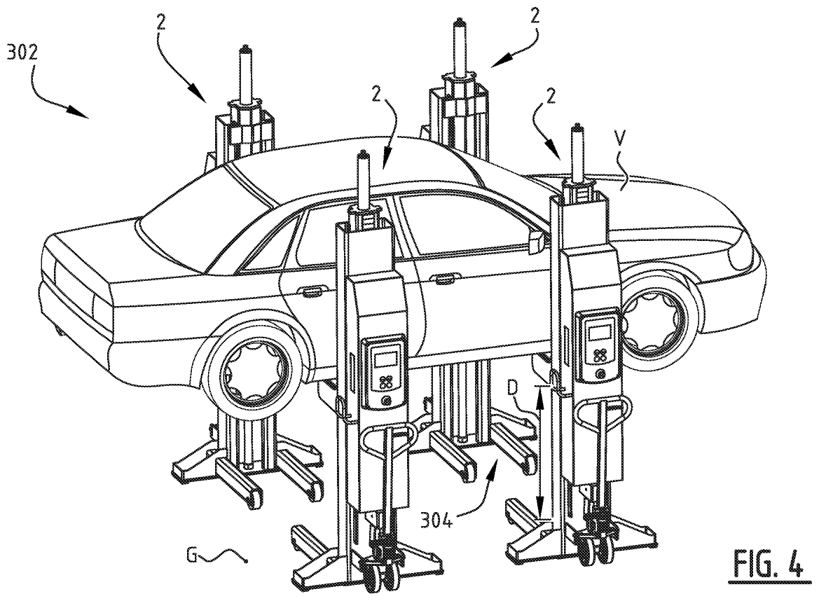

Lifting system 302 (FIG. 4) comprises a number of lifting columns 2 for lifting vehicle V from the ground surface G. Lifting columns 2 engage vehicle V on or at jack point 304.

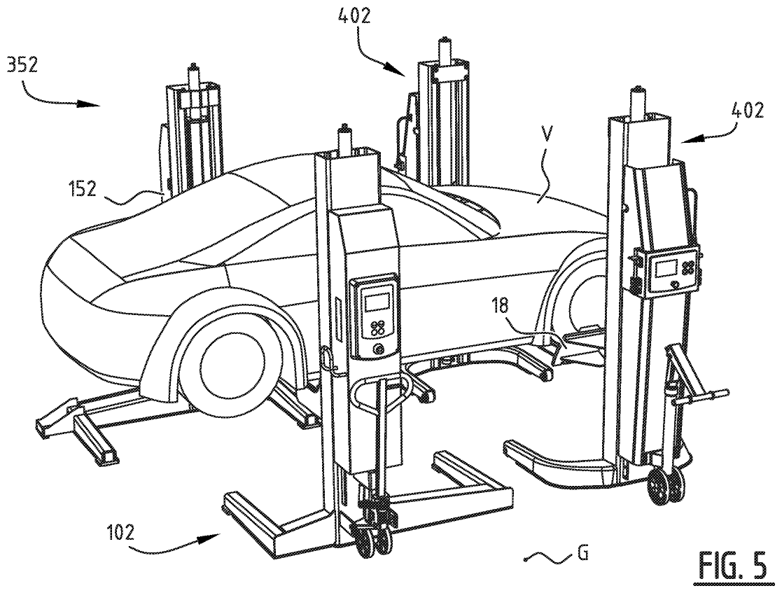

Alternative lifting system 352 (FIG. 5) comprises different types of lifting columns, including lifting column 102, lifting column 152 and two other lifting columns 402 for lifting vehicle V. It will be understood that any combination of lifting columns can be used to lift vehicle V depending on the availability of lifting columns and/or vehicle type, for example.

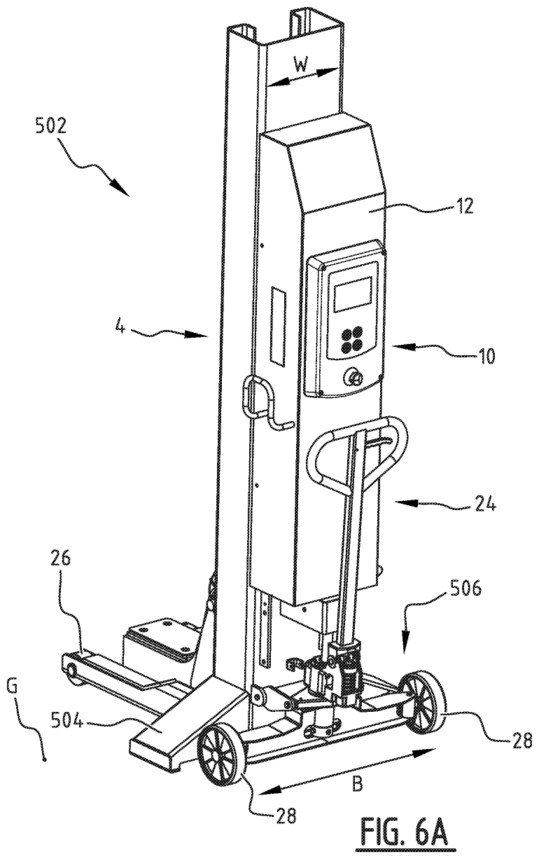

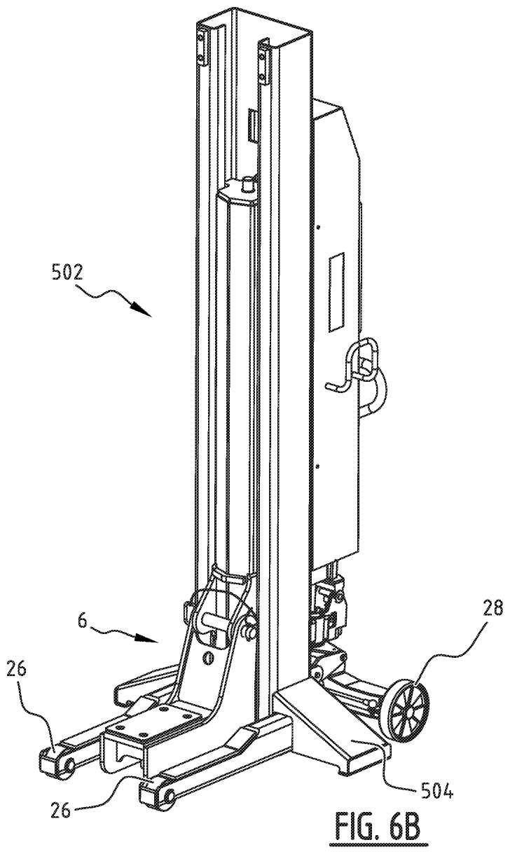

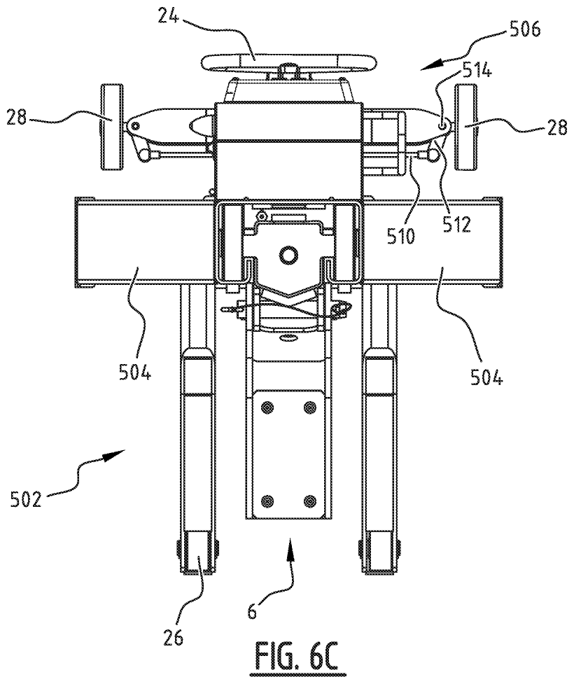

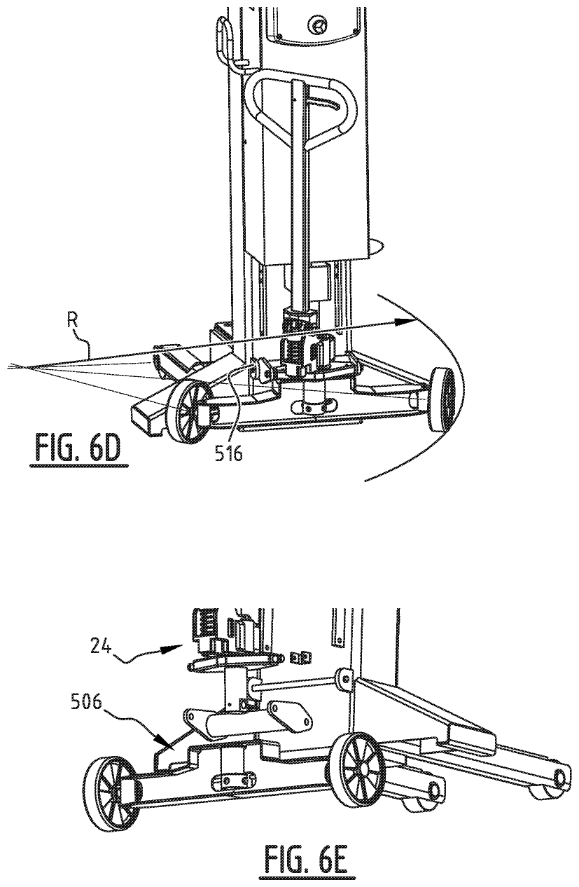

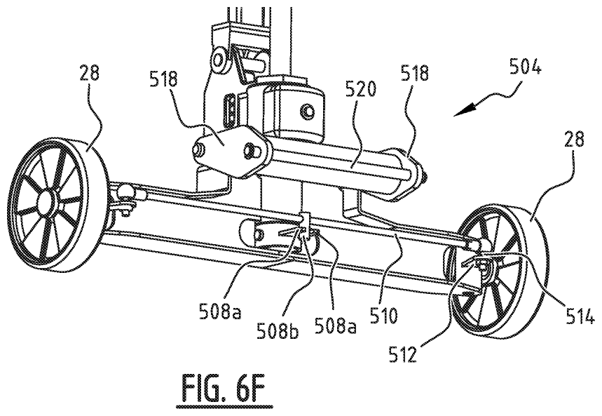

Mobile lifting column 502 (FIG. 6A-F) comprises mast 4, housing 12, control cabinet 10, displacement or pallet truck mechanism 24 to displace lifting column 502 over ground surface G using steering wheels 28 and front running wheels 26, and other relevant components of one or more of the other illustrated embodiments of lifting columns 2, 52, 102, 152, 202, 252, 402. Side supports 504 provide additional support to lifting column 502. In the illustrated embodiment two steering wheels 28 are provided in steering mechanism 506. Steering mechanism 506 comprises connectors 508a,b to connect pallet truck mechanism 24 with rod 510 that is connected to side bars 512 such that steering wheels 28 may rotate around shaft 514. Steering mechanism 506 enables a turning radius R of less than 2 meters. In the illustrated embodiment steering mechanism 506 is connected to frame 516 of lifting column 502 via sides 518 and shaft 520. Distance B between steering wheels 28 of pallet truck mechanism 24 is larger than corresponding distance Bs (FIG. 1A). Larger distance B (FIG. 6A) improves stability of column 502, especially during displacement. In the illustrated embodiment distance B is larger than width W of mast 4.

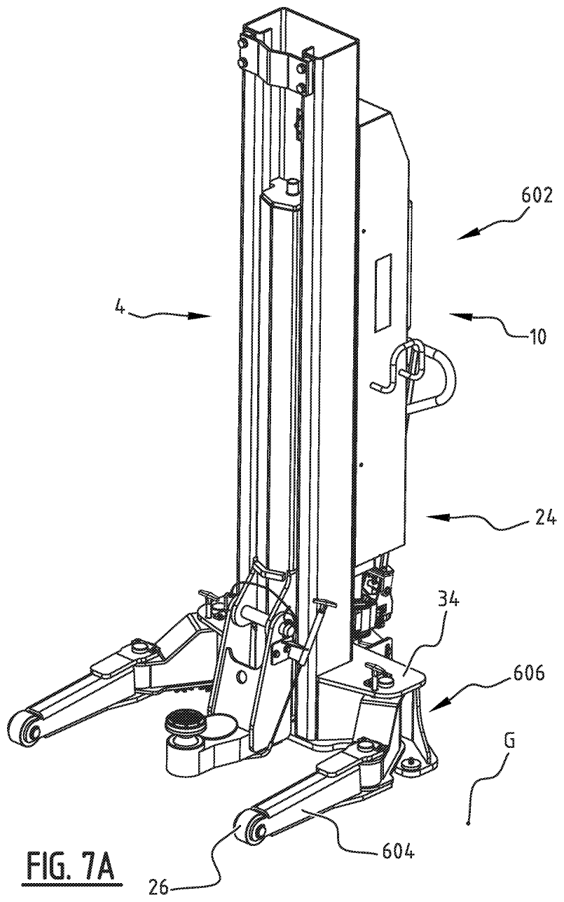

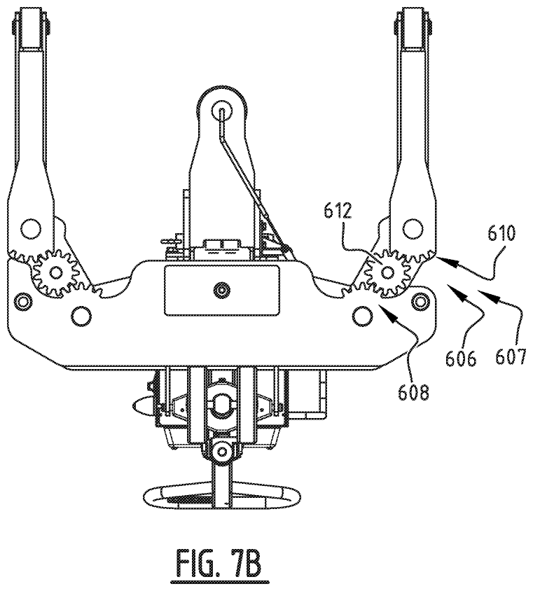

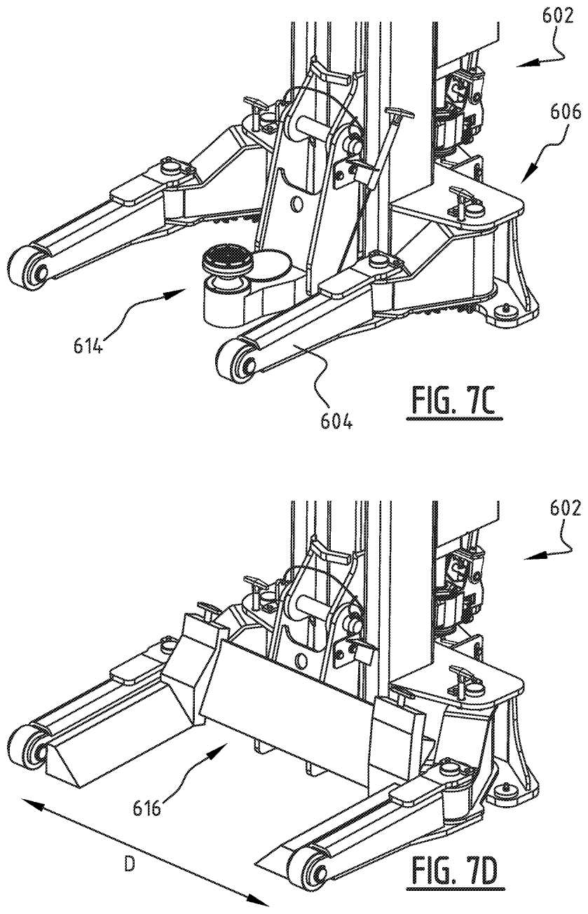

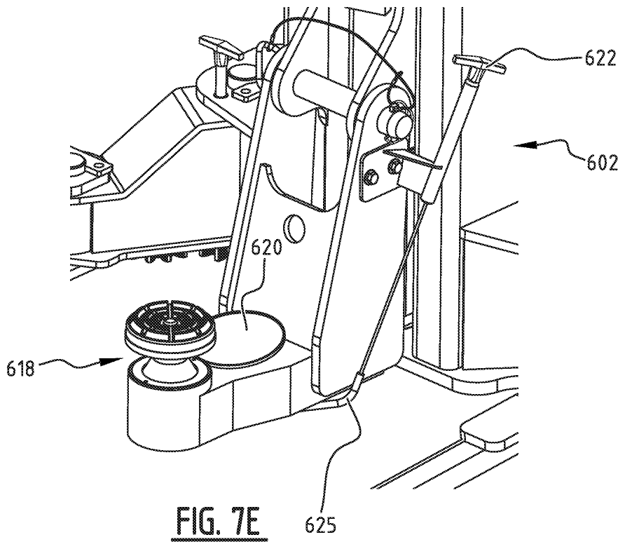

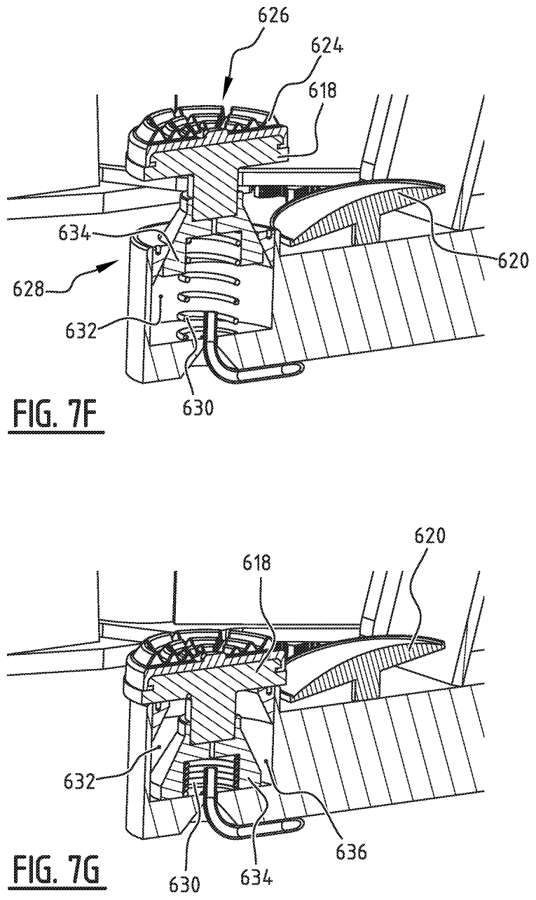

Mobile lifting column 602 (FIG. 7A-G) comprises mast 4, housing 12, control cabinet 10, displacement or pallet truck mechanism 24 to displace lifting column 602 over ground surface G using steering wheels 28 and front running wheels 26, and other relevant components of one or more of the other illustrated embodiments of lifting columns 2, 52, 102, 152, 202, 252, 402, 502.

Lifting column 602 comprises leg supports 604 having adjustment mechanism 606 that enables sideways adjustment of leg supports 604. Adjustment mechanism 606 is connected to side supports 34. In the illustrated embodiment mechanism 606 comprises connecting mechanism/gear assembly 607 having first gear 608 that is preferably integrated on leg support 604, second gear 610 that is preferably integrated on the frame of column 602, and third gear 612 connecting first and second gears. Third gear 612 is rotatable and enables keeping leg supports 604 substantially perpendicular to the rear of column 602. In the illustrated embodiment (e.g. FIG. 7A-B) gear assembly 607 is oriented with gears 608, 610, 612 in a substantially horizontal plane. It will be understood that other configurations for gear assembly 607 can also be envisaged, including other linkages without gears. Preferably, leg supports 604 can be positioned separately, e.g. see FIG. 7C. In this illustrated position of leg supports 604 the arm nearest to lifting point 614 will take up approximately 65% of the load. With leg supports 604 at a wider position having a larger mutual distance D sufficient room for wheel adapter 616 is provided (FIG. 7D).

In the illustrated embodiment of mobile lifting column 602 (FIG. 7E-G) there is provided spring loaded adapter 618 and mirror 620 for easy engagement of the pick-up point on vehicle V. T-shaped handle 622 can be pulled to lower pick-up plate 624 of adapter 618 using pull wire 625. Mobile lifting column 602 can be positioned observing the pick-up point in mirror 620. In use, T-handle 622 can be released and pick-up plate 624 will be in direct contact with the pick-up point on vehicle V, such as an electric bus. Friction elements 626 of pick-up plate 624 will keep it in this position and column 602 can be operated. In this illustrated embodiment spring mechanism 628 assists in maintaining adapter 618 in the correct position. In the illustrated embodiment spring mechanism 628 (FIG. 7F) comprises spring element 630 that is provided in chamber 632, and connector 634 that operatively connects spring element 630 to adapter 618. Adapter 618 can be provided in different positions, including an unloaded position (FIG. 7F) with adapter 618 in an upper position and wherein pull wire 625 is released, and including a loaded position (FIG. 7G) wherein adapter 618 is pushed down or wherein pull wire 625 is tight. In this illustrated embodiment some axial play 636 is provided to allow some movement of column 602 during lowering of pallet truck mechanism 24 while keeping adapter 618 engaged in position relative to vehicle V.

It will be understood that features illustrated for one of the illustrated lifting columns can also be applied to another lifting column, and can be used to lift vehicle V depending on the availability of lifting columns and/or vehicle type, for example. In use, when lifting system 302, 352 is selected from the available lifting columns 2, 52, 102, 152, 202, 252, 502 these lifting columns are positioned around vehicle V, preferably using their displacement or pallet truck mechanisms 24. Engagement elements 8 are positioned correctly relative to jack point 304. When the lifting operation is approved, carriers 6 start moving along masts 4. One or more of controllers 10 may detect an overload using load sensors 64 and/or height differences between the individual carriers 6 and/or speed differences between the individual carriers 6 and/or differences between the status and/or actions of drive(s) 20, and may calculate required control actions for lifting system 302, 352 as a whole and/or individual lifting columns thereof. The control actions are then communicated to the respective lifting column(s). After performing inspection, maintenance and/or repair on vehicle V, lifting system 302, 352 lowers vehicle V towards ground surface G and ends the lifting operation.

It will be understood that other embodiments, combinations of illustrated features, and configurations can be envisaged in accordance with the present invention.

The present invention is by no means limited to the above-described preferred embodiments. The rights sought are defined by the following claims within the scope of which many modifications can be envisaged. For example, lifting columns according to the invention include wired or wireless mobile type lifting columns.

1. A lifting column for lifting a vehicle, the lifting column comprising:
a frame comprising a ground support, and the frame being provided with a moveable carrier having an engagement element that is configured for engaging the vehicle at a jack point when carrying the vehicle; and
a lifting mechanism with a drive which acts on the carrier and is configured for raising and/or lowering the carrier relative to the frame,
wherein the ground support comprises:
two leg supports that extend under the vehicle when lifting the vehicle, and wherein the two leg supports are configured for providing stability in a first direction; and
side supports configured for providing stability in a second direction that is substantially perpendicular to the first direction.

2. The lifting column according to claim 1, wherein the side supports extend beyond the leg supports in a width direction of the lifting column.

3. The lifting column according to claim 1, wherein the leg supports extend substantially parallel to the carrier with the engagement element, and wherein the leg supports extend beyond the carrier.

4. The lifting column according to claim 3, wherein the leg supports are connected to each other at their free ends.

5. The lifting column according to claim 1, wherein the leg supports are positioned such that the leg supports are on one side of the wheel when lifting the vehicle.

6. The lifting column according to claim 1, wherein the carrier is at least partly removable from the frame to enable changing the engagement element.

7. The lifting column according to claim 1, wherein the engagement element can be extended and retracted relative to the frame and/or who in the engagement element can be raised and/or lowered relative to the carrier.

8. (canceled)

9. The lifting column according to claim 1, wherein the leg supports are positioned on both sides of the carrier and asymmetrically relative to the carrier.

10. The lifting column according to claim 1, wherein the carrier comprises a rotation axis to enable rotation of the carrier relative to the frame and wherein the rotation axis extends in a substantially vertical direction.

11. (canceled)

12. The lifting column according to claim 1, further comprising a load sensor configured for determining the load that is carried by the carrier.

13. The lifting column according to claim 1, further comprising a side-shift mechanism for the leg supports.

14. The lifting column according to claim 1, further comprising a steering mechanism with two or more steering wheels.

15. The lifting column according to claim 14, wherein the steering wheels are placed at a mutual distance that is larger than a width of a mast of the frame.

16. The lifting column according to claim 1, further comprising an adjustment mechanism that enables sideways adjustment of leg supports.

17. The lifting column according to claim 16, wherein the adjustment mechanism is configured for connecting a leg support to a side support with a gear assembly.

18. The lifting column according to claim 1, further comprising a spring loaded adapter configured for engaging a vehicle, and a mirror configured for checking engagement with the vehicle.

19. The lifting column according to claim 18, wherein the adapter further comprising an axial play configured for allowing some movement of the column during positioning thereof.

20. A lifting system comprising at least one lifting column, wherein the lifting column comprising:
a frame comprising a ground support, and the frame being provided with a moveable carrier having an engagement element that is configured for engaging the vehicle at a jack point when carrying the vehicle; and
a lifting mechanism with a drive which acts on the carrier and is configured for raising and/or lowering the carrier relative to the frame,
wherein the ground support comprises:
two leg supports that extend under the vehicle when lifting the vehicle, and wherein the two leg supports are configured for providing stability in a first direction; and
side supports configured for providing stability in a second direction that is substantially perpendicular to the first direction.

21. A method for lifting a vehicle, comprising the steps of:
providing a lifting system with at least one lifting column, wherein the lifting column comprising:
a frame comprising a ground support, and the frame being provided with a moveable carrier having an engagement element that is configured for engaging the vehicle at a jack point when carrying the vehicle; and
a lifting mechanism with a drive which acts on the carrier and is configured for raising and/or lowering the carrier relative to the frame,
wherein the ground support comprises:
two leg supports that extend under the vehicle when lifting the vehicle, and wherein the two leg supports are configured for providing stability in a first direction; and
side supports configured for providing stability in a second direction that is substantially perpendicular to the first direction;
positioning the lifting column relative to the vehicle; and
engaging the vehicle at a jack point and lifting the vehicle.

22. The method according to claim 21, further comprising the step of selecting and mounting an engagement element.
